(19) United States
(12) Patent Application Publication
(10) Pub. No.: US 2013/0271695 A1
(43) Pub. Date: Oct. 17, 2013

(54) BACK BEZEL OF BACKLIGHT MODULE AND LIQUID CRYSTAL DISPLAY USING THE SAME

(71) Applicants: Quan Li, Shenzhen (CN); Yicheng Kuo, Shenzhen (CN); Yuchum Hsiao, Shenzhen (CN)

(72) Inventors: Quan Li, Shenzhen (CN); Yicheng Kuo, Shenzhen (CN); Yuchum Hsiao, Shenzhen (CN)

(21) Appl. No.: 13/574,734

(22) PCT Filed: Jun. 1, 2012
(86) PCT No.: PCT/CN2012/076371

§ 371 Date: Jul. 23, 2012

(30) Foreign Application Priority Data
Apr. 13, 2012 (CN) 201210107774.5

(51) Int. Cl. G02F 1/1333; G02F 1/1335

(52) U.S. Cl. CPC G02F 1/133308; G02F 1/1336
USPC 349/58; 312/223.1

(57) ABSTRACT

A back bezel includes a flat plate of which the periphery of the flat plate is formed by first sides and second sides abutted together; a set of first side strip is disposed on the position corresponding to that of the first side, the first side strip has a first frame which is laterally connected with a first supporting part, the longitudinal length of the first supporting part is smaller than that of the first frame, and the first side connects with the first supporting part; a set of second side strips are disposed on positions corresponding to positions of the second sides, the second side strip has a second frame which is laterally connected with a second supporting part, the second side connects with the second supporting part, the longitudinal side of the second supporting part connects with the longitudinal side of the first supporting part.

### FIELD OF THE INVENTION

The present invention relates to a liquid crystal display (LCD) device, and more particularly to a back bezel for large size liquid crystal panels.

### BACKGROUND OF THE INVENTION

The conventional LCD device includes a front frame, a liquid crystal panel, and a backlight module, wherein the backlight module includes a back bezel, a reflective sheet, a light guiding plate, and lamp sets.

In the current market, various sizes of liquid crystal panels are produced in order to meet customers' need. For example, the liquid crystal panels have the sizes of 31.5, 42, 46, 48 or 55 inches for middle/large size television sets, and the sizes of 60, 67, 72, 84, 90 or even more than 110 inches for extra large size television sets. Therefore, the different sizes of back bezel dies are required according to the sizes of the liquid crystal panels.

One-piece back bezel is normally adopted for middle and small size liquid crystal panels in the current technology. The one-piece back bezel is usually formed by punching metal sheets or a plastic injection molding process. However, the one-piece back bezel consumes too many raw materials, led to high material costs. In addition, for middle and large size liquid crystal panels, it may require large punching machines to make such back bezels. Besides, the structures of middle or large size back bezel dies are complicated and require high costs for manufacturing.

Especially for extra large size liquid crystal panels, such as panels with sizes more than 100 inches, it also requires to use extra large size back bezels. However, current industry does not provide such large punching machines for manufacturing extra large size back bezels; therefore, the extra large size back bezels are formed by assembling joint elements. But, it also requires designing several dies for making the joint elements in order to assemble the extra large size back bezel, such that the costs are increased. Moreover, if many joint elements are required for assembling a back bezel, it may have lack of assembly strength and difficult-to-assemble problems.

Thus, for producing middle and large size liquid crystal panels, especially for extra large liquid crystal panels, how to design a back bezel structure with light weight and high strength is a top priority for the industry, so as to solve the problems of plural dies required, high costs, and difficult-to-assemble.

### SUMMARY

The objective of the present invention is to solve the insufficiency of current available technologies, and the present invention is directed to a back bezel of backlight module and a liquid crystal display device using the same by reducing the number of jointing to achieve cost saving.

A back bezel applied to large size LCD devices is provided in the present invention to overcome the above mentioned problems. The back bezel comprises a flat plate of which the periphery of the flat plate is formed by a plurality set of first sides and second sides abutted together. A set of first side strips made of an aluminum extruded type material is disposed on the positions corresponding to that of the first sides. The first side strip has a first frame and a first supporting part. The first frame is laterally connected with the first supporting part. The longitudinal length of the first supporting part is smaller than that of the first frame, and the first supporting part is connected with the first side. A set of second side strips made of an aluminum extruded type material is disposed on the positions corresponding to that of the second sides. The second side strip has a second frame and a second supporting part. The second frame is laterally connected with the second supporting part. The longitudinal length of the second supporting part is longer than the length of the second side. The second supporting part is connected with the second side, and the longitudinal side of the second supporting part is connected with the longitudinal side of the first supporting part.

In one embodiment of the present invention, the first supporting part has a first connecting part in the lateral side edge thereof. The longitudinal length of the first connecting part is smaller than that of the first supporting part. The first connecting part surface of the first connecting part is lower than the first supporting part surface of the first supporting part. Moreover, the first side is brought into engagement with the first connecting part.

In one embodiment of the present invention, the second supporting part has a second connecting part in the lateral side edge thereof. The second connecting part surface of the second connecting part is lower than the second supporting part surface of the second supporting part. The second side is brought into engagement with the second connecting part. The two ends of the first supporting part in longitudinal directions are brought into engagement with the second connecting parts.

In one embodiment of the present invention, the first side and the first supporting part and/or the second side and the second supporting part are fixed together by using screws, rivets or welding.

In one embodiment of the present invention, the back bezel is applied to a liquid crystal panel having a size more than 100 inches.

In one embodiment of the present invention, the flat plate is composed of a plurality of aluminum (Al) sheets, and the thickness of the Al sheet is at least 3 mm and the Al sheet is formed and processed by computer numerical control (CNC) machines.

A liquid crystal display device is provided in the present invention to overcome the above mentioned problems. The liquid crystal display device comprises a backlight module, a liquid crystal panel, and a back bezel accommodated the backlight module and the liquid crystal panel in sequence. The back bezel comprises a flat plate, a set of first side strips, and a set of second side strips. The periphery of the flat plate is formed by a plurality set of first sides and second sides abutted together. The set of first side strips made of an aluminum extruded type material is disposed on the positions corresponding to that of the first sides. The first side strip has a first frame and a first supporting part, and the first frame is laterally connected with the first supporting part. The longitudinal length of the first supporting part is smaller than that of the first frame, and the longitudinal length of the first frame is longer than the length of the first side. Moreover, the first supporting part is connected with the first side. The set of second side strips made of an aluminum extruded type material is disposed on the positions corresponding to that of the second sides. The second side strip has a second frame and a second supporting part. The second frame is laterally connected with the second supporting part. The longitudinal length of the second frame is longer than the length of the second side. The second supporting part is connected with the second side, and the longitudinal side of the second supporting part is connected with the longitudinal side of the supporting part.

Compared with the conventional technologies, a joint method is adopted in the present invention, in which the side strips made of aluminum extruded type material are disposed around the back bezel and a plurality of aluminum sheets are disposed on the middle of the back bezel; therefore, the dies used for aluminum extruded type material in the present invention are simple and the price is cheap; in addition, the length of the side strip made of aluminum extruded type material may be up to several meters, for example: 6 meters, such that the joint method of the present invention can reduce the number of jointing. Moreover, the partial thickness of the side strip made of aluminum extruded type material can be adjusted so as to enhance the strength in partial areas. Furthermore, the thicker aluminum sheets can be processed by computer numerical control (CNC) machines, such that the present invention only requires small amount of dies so as save a lot of costs.

### BRIEF DESCRIPTION OF THE DRAWINGS

FIG. 1 a perspective view of a modulized back bezel applied to large size liquid crystal display (LCD) panels according to one embodiment of the present invention.

FIG. 2 is a detail view of the modulized back bezel shown in FIG. 1.

FIG. 3 is a perspective view of an aluminum sheet structure according to one embodiment of the present invention.

FIG. 4 is a perspective view of a first side strip according to one embodiment of the present invention.

FIG. 5 is a perspective view of a second side strip according to one embodiment of the present invention.

FIG. 6 is a front view of an LCD device according to one embodiment of the present invention, wherein the back bezel is a cross section view taken along line A-A of FIG. 1.

### DETAILED DESCRIPTION OF THE INVENTION

Hereinafter, preferred embodiments of the present invention will be described in detail with reference to the accompanying drawings.

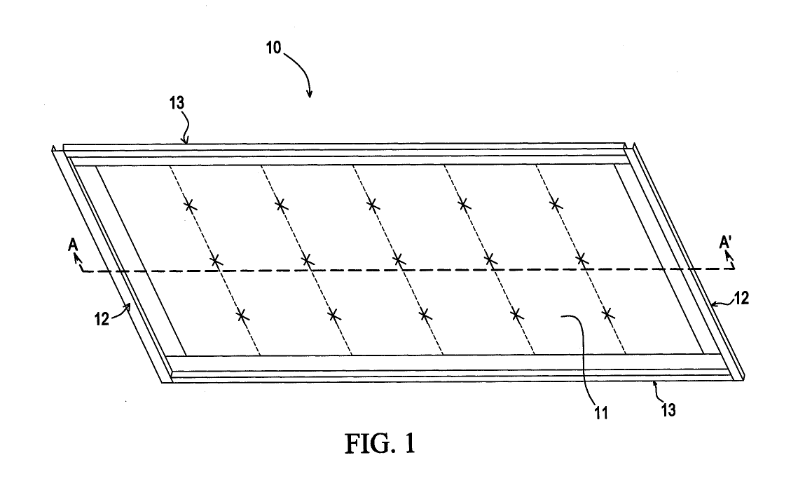

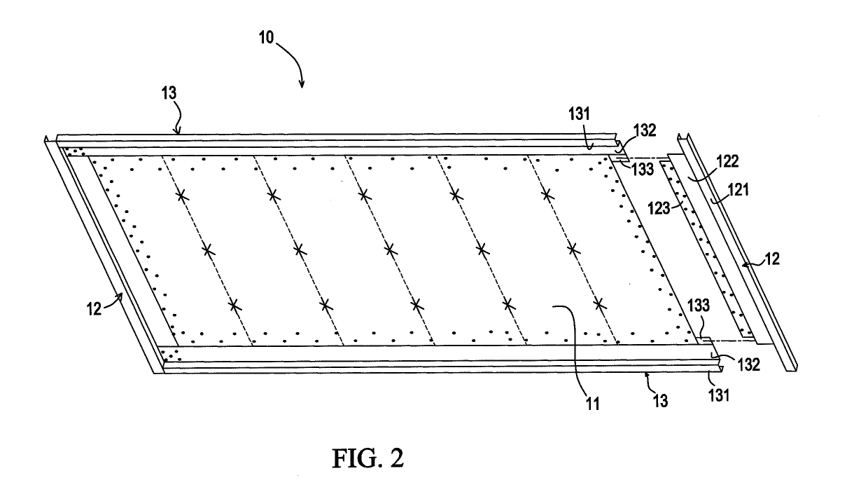

Please refer to FIG. 1, it is a perspective view of a modulized back bezel applied to large size liquid crystal display (LCD) panels according to one embodiment of the present invention. FIG. 2 is a detail view of the modulized back bezel shown in FIG. 1. In FIGS. 1 and 2, the back bezel 10 of the embodiment is capable to accommodate a backlight module 20 and a liquid crystal panel 30. The back bezel 10 comprises a flat plate 11, a first side strip 12, and a second side strip 13. The periphery of the flat plate 11 is formed by a plurality set of first sides 111 and second sides 112 abutted together.

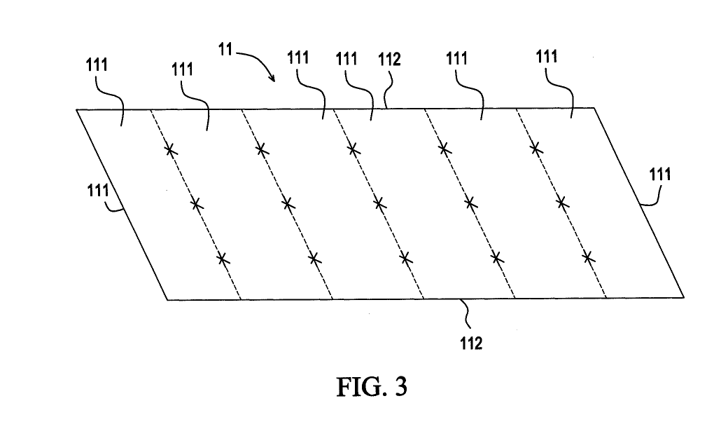

FIG. 3 is a perspective view of an aluminum sheet structure according to one embodiment of the present invention. In the embodiment, the flat plate 11 may be composed of a plurality of Al sheets 111. The thickness of the Al sheet 111 is at least 3 mm and the Al sheet 111 is formed and processed by computer numerical control (CNC) machines.

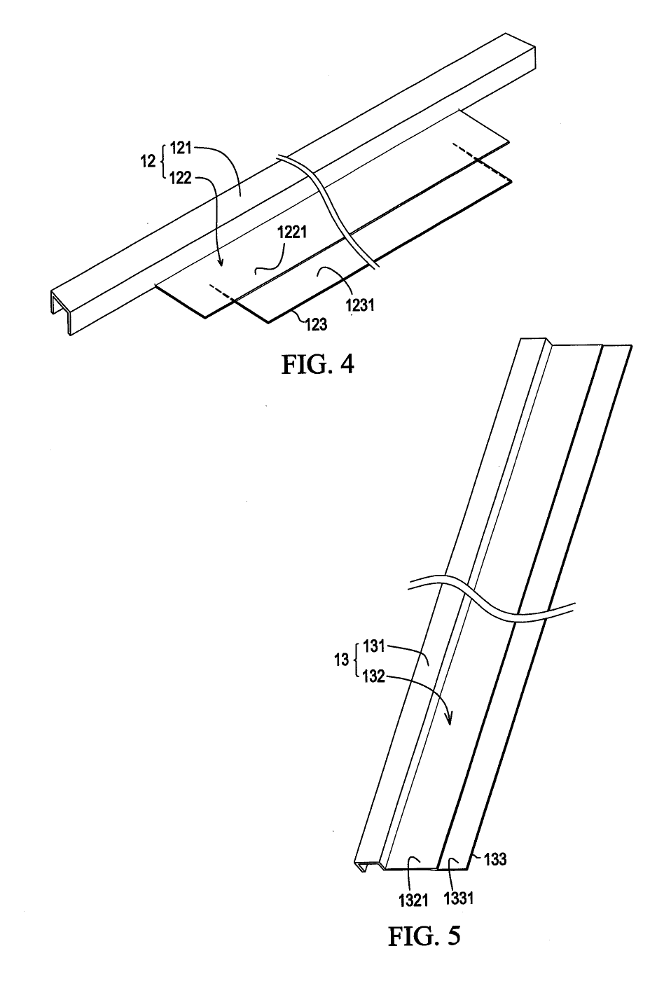

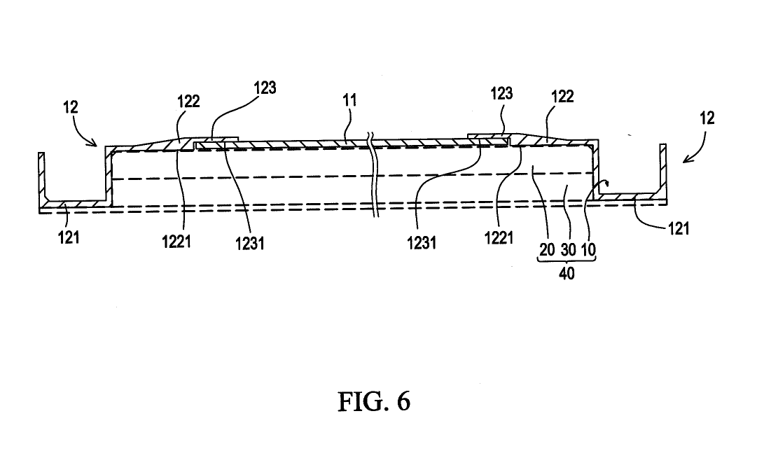

Please refer to FIG. 4, it is a perspective view of a first side strip according to one embodiment of the present invention, and FIG. 6 is a front view of an LCD device according to one embodiment of the present invention. The first side strip 12 is an aluminum extruded type member disposed on a position corresponding to that of the first side 111. The first side strip 12 has a first frame 121 and a first supporting part 122. The first frame 121 is laterally connected with the first supporting part 122. The longitudinal length of the first supporting part 122 is smaller than that of the first frame 121, and the longitudinal length of the first frame 121 longer than that of the first side 111. The first supporting part 122 is connected with the first side 111, and the first supporting part 122 has a first connecting part 123 in the lateral side edge thereof. The longitudinal length of the first connecting part 123 is smaller than that of the first supporting part 122. The first connecting part surface 1231 of the first connecting part 123 is lower than the first supporting part surface 1221 of the first supporting part 122. In addition, the first side 111 is brought into engagement with the first connecting part 123 as shown in FIG. 6

Please refer to FIG. 5, it is a perspective view of a second side strip according to one embodiment of the present invention, and FIG. 6 is a front view of the LCD according to one embodiment of the present invention. The second side strip 13 is an aluminum extruded type member disposed on a position corresponding to that of the second side 112. The second side strip 13 has a second frame 131 and a second supporting part 132. The second frame 131 is laterally connected with the second supporting part 132. The longitudinal length of the second frame 131 is longer than the length of the second side 112. The second supporting part 132 is connected with the second side 112, and the longitudinal side of the second supporting part 132 is connected with the longitudinal side of the first supporting part 122. The second supporting part 132 has a second connecting part 133 in the lateral side edge thereof. In addition, the second connecting part surface 1321 of the second connecting part 133 is lower than the second supporting part surface 1331 of the second supporting part 132. The second side 112 is brought into engagement with the second connecting part 133 as shown in FIG. 6

In the above embodiments, the first side 111 and the first supporting part 122 and/or the second side 112 and the second supporting part 132 can be fixed together preferably by using screws to form a modulized assembly structure, but they may be fixed together by using rivets or welding.

In the above embodiments, the liquid crystal panel 30 may be a liquid crystal panel having a size more than 100 inches.

Please refer to FIG. 6, it is a front view of the LCD device according to one embodiment of the present invention, wherein the back bezel is a cross section view taken along line A-A of FIG. 1. The LCD device 40 of an embodiment comprises: a backlight module 20, a liquid crystal panel 30, and a back bezel 10 which accommodates the backlight module 20 and the liquid crystal panel 30 in sequence as mentioned in previous embodiments.

The characteristic of the present invention lies in that: a flat plate, especially an aluminum sheet, is processed by a computer numerical control machine to solve the difficulty of punching thick materials. Then, by using small amount of dies, the aluminum materials are respectively extruded into side strips, and the partial thickness of the side strip made of aluminum extruded type material can be adjusted so as to enhance the strength in partial areas, and the length of the aluminum side strip may up to six meters. The above-mentioned manufacturing processes mainly explain that the structure strength of the back bezel can be effectively enhanced by the combinations of large size aluminum sheets and the side strips.

Moreover, the flat plates and the side strips may be riveted or welded together as a whole, therefore, the problems of requiring a lot amount of dies, high costs, and complex assembling can be overcome, and the purposes of light weight and high strength for back bezels can be achieved.

Although the present disclosure has been described in terms of exemplary embodiments, the embodiments disclosed in this application are to be considered in all respects as illustrative and not limiting. It should be appreciated that all modifications or changes that come within the meaning and range of equivalency of the claims may be made in the embodiments described by persons skilled in the art without departing from the scope of the present disclosure as defined by the following claims.

What is claimed is:

1. A back bezel for accommodating a backlight module and a liquid crystal panel, comprising:
a flat plate, a periphery of the flat plate is formed by a plurality set of first sides and second sides abutted together;
a set of first side strips, the first side strips made of an aluminum extruded type material are disposed on positions corresponding to positions of the first sides, the first side strip has a first frame and a first supporting part, the first frame is laterally connected with the first supporting part, a longitudinal length of the first supporting part is smaller than a longitudinal length of the first frame, the longitudinal length of the first frame is longer than a length of the first side, and the first supporting part is connected with the first side, the first supporting part has a first connecting part in a lateral side edge of the first supporting part, a longitudinal length of the first connecting part is smaller than the longitudinal length of the first supporting part, a first connecting part surface of the first connecting part is lower than a first supporting part surface of the first supporting part, and the first side is brought into engagement with the first connecting part; and
a set of second side strips, the second side strips made of an aluminum extruded type material are disposed on positions corresponding to positions of the second sides, the second side strip has a second frame and a second supporting part, the second frame is laterally connected with the second supporting part, a longitudinal length of the second frame is longer than a length of the second side, the second supporting part is connected with the second side, and a longitudinal side of the second supporting part is connected with a longitudinal side of first supporting part, the second supporting part has a second connecting part in a lateral side edge of the second supporting part, a second connecting part surface of the second connecting part is lower than a second supporting part surface of the second supporting part, and the second side is brought into engagement with the second connecting part,
wherein two ends of the first supporting part in a longitudinal direction are brought into engagement with the second connecting part, the first side and the first supporting part and/or the second side and the second supporting part are fixed together by using a screw, the liquid crystal panel has a size more than 100 inches, the flat plate is composed of a plurality of aluminum sheets, a thickness of the aluminum sheet is at least 3 mm, and the aluminum sheet is formed and processed by a computer numerical control machine.

2. A back bezel for accommodating a backlight module and a liquid crystal panel, comprising:
a flat plate, a periphery of the flat plate is formed by a plurality set of first sides and second sides abutted together;
a set of first side strips, the first side strips made of an aluminum extruded type material are disposed on positions corresponding to positions of the first sides, the first side strip has a first frame and a first supporting part, the first frame is laterally connected with the first supporting part, a longitudinal length of the first supporting part is smaller than a longitudinal length of the first frame, the longitudinal length of the first frame is longer than a length of the first side, and the first supporting part is connected with the first side; and
a set of second side strips, the second side strips made of an aluminum extruded type material are disposed on positions corresponding to positions of the second sides, the second side strip has a second frame and a second supporting part, the second frame is laterally connected with the second supporting part, a longitudinal length of the second frame is longer than a length of the second side, the second supporting part is connected with the second side, and a longitudinal side of the second supporting part is connected with a longitudinal side of first supporting part.

3. The back bezel according to claim 2, wherein the first supporting part has a first connecting part in a lateral side edge of the first supporting part, a longitudinal length of the first connecting part is smaller than a longitudinal length of the first supporting part, a first connecting part surface of the first connecting part is lower than a first supporting part surface of the first supporting part, and the first side is brought into engagement with the first connecting part.

4. The back bezel according to claim 2, wherein the second supporting part has a second connecting part in a lateral side edge of the second supporting part, a second connecting part surface of the second connecting part is lower than a second supporting part surface of the second supporting part, and the second side is brought into engagement with the second connecting part.

5. The back bezel according to claim 4, wherein two ends of the first supporting part in a longitudinal direction are brought into engagement with the second connecting part.

6. The back bezel according to claim 2, wherein the first side and the first supporting part and/or the second side and the second supporting part are fixed together by using a screw.

7. The back bezel according to claim 3, wherein the first side and the first supporting part and/or the second side and the second supporting part are fixed together by using a screw.

8. The back bezel according to claim 4, wherein the first side and the first supporting part and/or the second side and the second supporting part are fixed together by using a screw.

9. The back bezel according to claim 2, wherein the first side and the first supporting part and/or the second side and the second supporting part are fixed together by using a rivet.

10. The back bezel according to claim 3, wherein the first side and the first supporting part and/or the second side and the second supporting part are fixed together by using a rivet.

11. The back bezel according to claim 4, wherein the first side and the first supporting part and/or the second side and the second supporting part are fixed together by using a rivet.

12. The back bezel according to claim 2, wherein the first side and the first supporting part and/or the second side and the second supporting part are fixed together by welding.

13. The back bezel according to claim 3, wherein the first side and the first supporting part and/or the second side and the second supporting part are fixed together by welding.

14. The back bezel according to claim 4, wherein the first side and the first supporting part and/or the second side and the second supporting part are fixed together by welding.

15. The back bezel according to claim 2, wherein the liquid crystal panel has a size more than 100 inches.

16. The back bezel according to claim 2, wherein the flat plate is composed of a plurality of aluminum sheets, a thickness of the aluminum sheet is at least 3 mm, and the aluminum sheet is formed and processed by a computer numerical control (CNC) machine.

17. A liquid crystal display device, comprising:
a backlight module;
a liquid crystal panel; and
a back bezel accommodated the backlight module and the liquid crystal panel in sequence, comprising:
a flat plate, a periphery of the flat plate is formed by a plurality set of first sides and second sides abutted together;
a set of first side strips, the first side strips made of an aluminum extruded type material are disposed on positions corresponding to positions of the first sides, the first side strip has a first frame and a first supporting part, the first frame is laterally connected with the first supporting part, a longitudinal length of the first supporting part is smaller than a longitudinal length of the first frame, the longitudinal length of the first frame is longer than a length of the first side, and the first supporting part is connected with the first side; and
a set of second side strips, the second side strips made of an aluminum extruded type material are disposed on positions corresponding to positions of the second sides, the second side strip has a second frame and a second supporting part, the second frame is laterally connected with the second supporting part, a longitudinal length of the second frame is longer than a length of the second side, the second supporting part is connected with the second side, and a longitudinal side of the second supporting part is connected with a longitudinal side of first supporting part.
